(19) United States
(12) Patent Application Publication
(10) Pub. No.: US 2015/0170329 A1
(43) Pub. Date: Jun. 18, 2015

(54) SIGNAL PROCESSING APPARATUS FOR DETECTING/CORRECTING ECLIPSE PHENOMENON

(71) Applicant: Himax Imaging, Inc., Grand Cayman (KY)

(72) Inventors: Ping-Hung Yin, Grand Cayman (KY); Kaveh Moazzami, Grand Cayman (KY); Satya Narayan Mishra, Grand Cayman (KY); Amit Mittra, Grand Cayman (KY)

(21) Appl. No.: 14/629,494

(22) Filed: Feb. 24, 2015

Related U.S. Application Data
(62) Division of application No. 13/802,500, filed on Mar. 13, 2013.

(51) Int. Cl. G06T 3/00; H04N 5/378; G06T 5/00

(52) U.S. Cl. CPC G06T 3/00; G06T 5/00; H04N 5/378

(57) ABSTRACT

A signal processing apparatus includes a correlated double sampling unit and a processing unit. The correlated double sampling unit is arranged for receiving a reset signal and a data signal, obtaining a reset level and a first data level corresponding to the reset signal and the data signal, respectively, and outputting an output signal according to a level difference between the reset level and the first data level. The processing unit is coupled to the correlated double sampling unit, and is arranged for receiving a second data level of the data signal and a predetermined level, and comparing the second data level with the predetermined level to generate a detection result indicative of quality of the level difference.

### CROSS REFERENCE TO RELATED APPLICATIONS

This divisional application claims the benefit of co-pending U.S. patent application Ser. No. 13/802,500, filed on Mar. 13, 2013 and incorporated herein by reference.

### BACKGROUND OF THE INVENTION

1. Field of the Invention

The disclosed embodiments of the present invention relate to an image sensor, and more particularly, to a signal processing apparatus for detecting or correcting an eclipse/darkle phenomenon (e.g. the dark sun phenomenon).

2. Description of the Prior Art

Many optical transducer image sensor systems that transform optical signals to electrical signals utilize a method called correlated double sampling (CDS), which generate a pixel data by subtraction of a reset signal from an optical signal. The reset signal is an indicator of the offset and the initial value corresponding to a first stage readout circuitry operating on an image unit (e.g. a pixel), and the optical signal corresponds to the operation result of the first stage readout circuitry on the image unit (e.g. a pixel). A dark-sun effect occurs in the presence of a strong light which will disturb the reset signal causing an area that is supposed to indicate a large amplitude (e.g. very bright in optical systems) to be reduced in intensity so that it either appears as zero intensity (e.g. dark or black in optical sensors) or appears with lower intensity (e.g. grey in optical sensors). Thus, there is a need for an innovative design which can detect and correct the aforementioned dark-sun effect.

### SUMMARY OF THE INVENTION

In accordance with exemplary embodiments of the present invention, a signal processing apparatus for detecting and correcting the eclipse/darkle phenomenon (e.g. the dark sun phenomenon) is proposed to solve the above-mentioned problem.

According to an embodiment of the present invention, an exemplary signal processing apparatus is provided. The exemplary signal processing apparatus includes a correlated double sampling unit and a processing unit. The correlated double sampling unit is arranged for receiving a reset signal and a data signal, obtaining a reset level and a first data level corresponding to the reset signal and the data signal, respectively, and outputting an output signal according to a level difference between the reset level and the first data level. The processing unit is coupled to the correlated double sampling unit, and arranged for receiving a second data level of the data signal and a predetermined level, and comparing the second data level with the predetermined level to generate a detection result indicative of quality of the level difference.

The sensitivity for the proposed eclipse/darkle detection mechanism is higher than methods which rely on the reset level comparison to a constant threshold since the sensitivity obtained from the reset level is lower due to the lower sensitivity of the floating diffusion node compared to the photodiode sensitivity. Hence, the eclipse/darkle detection mechanism presented is more effective.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an exemplary correlated double sampling apparatus of the readout circuit shown in FIG. 5.

FIG. 2 is a diagram illustrating an exemplary implementation of the correlated double sampling apparatus shown in FIG. 1.

FIG. 3 is a timing diagram illustrating the timing sequence corresponding to the correlated double sampling apparatus shown in FIG. 2.

FIG. 4 is a block diagram illustrating an exemplary signal processing apparatus according to an embodiment of the present invention.

FIG. 5 is a block diagram illustrating an exemplary image sensor according to an embodiment of the present invention.

### DETAILED DESCRIPTION

The disclosed apparatus and method for detecting and correcting the eclipse/darkle phenomenon (e.g. the dark sun phenomenon) may be applicable to any transducer system working on any type of signal that is transformed into electrical signals by subtraction of two levels. For purposes of explanation, however, embodiments of the present invention with reference to an optical image sensor system are set forth in order to provide thorough understanding of technical features of the present invention. It will be evident to one skilled in the art that the present invention as defined by the claims may include some or all of the features in this example alone or in combination with other features described below, and may further include modifications and equivalents of the features and concepts described herein as well as variations which closely follow the concepts present in this invention.

In a case where the proposed apparatus and method for detecting and correcting the eclipse/darkle phenomenon is employed in image sensors, a phenomenon called dark sun (or “black sun”) as well as grey sun phenomenon that occurs under the presence of a high intensity bright object, such as (but not limited to) sun, stars, laser sources or various other light sources, may be detected/corrected based on the comparison of the value at the end of signal transfer period with a fixed level.

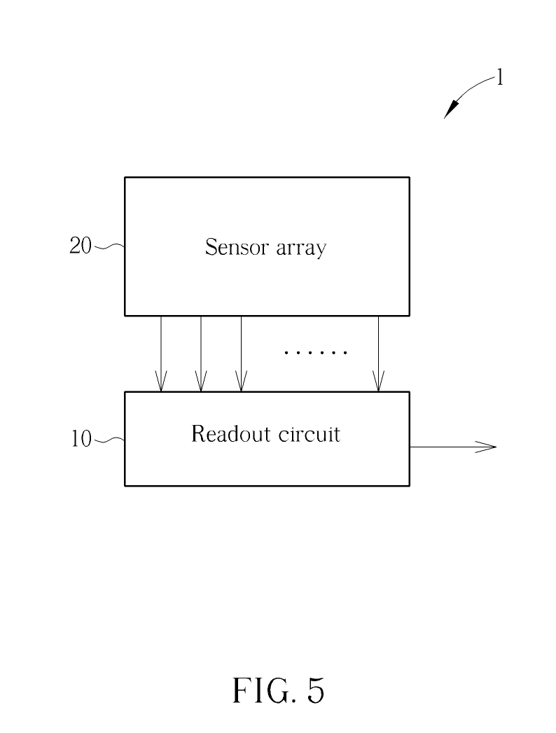

FIG. 5 is a block diagram illustrating an exemplary image sensor according to an embodiment of the present invention. The image sensor 1 includes a sensor array 20 and a readout circuit 10. The sensor array 20 includes pixels (not shown in FIG. 5), which further include photodiodes (not shown in FIG. 5), for sensing light to generate data signals. The readout circuit 10 may perform correlated double sampling (CDS) operation to receive reset signals and the data signals of the pixels to generate output signals.

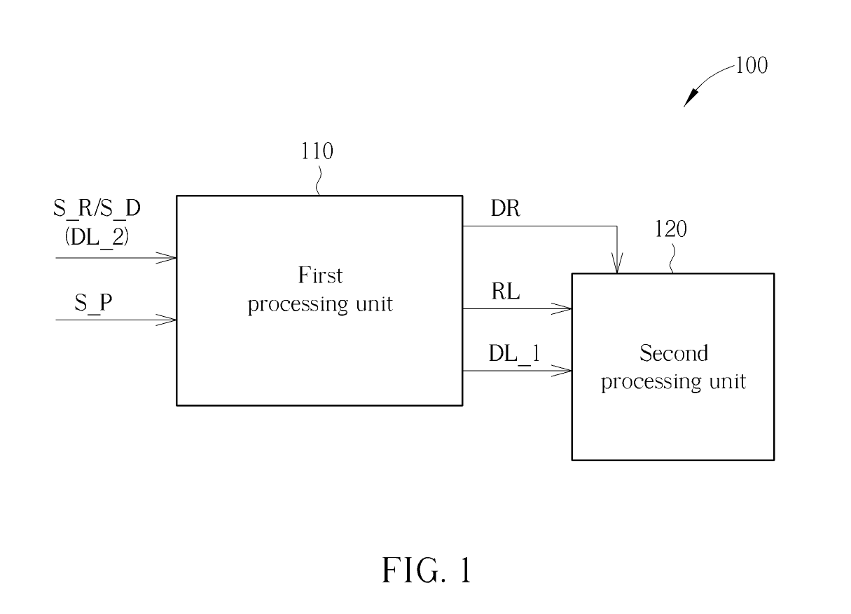

Please refer to FIG. 1, which is a block diagram illustrating an exemplary CDS apparatus 100 of the readout circuit 10 shown in FIG. 5. The CDS apparatus 100 is for example a column amplifier, and includes, but is not limited to, a first processing unit 110 and a second processing unit 120 coupled to the first processing unit 110. The first processing unit 110 may be arranged for receiving a reset signal S_R, a data signal S_D, and a predetermined signal S_P. In a first operation mode for readout (e.g. the normal CDS operation), the first processing unit 110 is arranged for obtaining a reset level RL of the reset signal S_R and a first data level DL_1 of the data signal S_D from a previous stage (e.g. a pixel including a photodiode), and the second processing unit 120 is arranged for storing the reset level RL and the first data level DL_1.

In a second operation mode for detecting the dark-sun effect, the first processing unit 110 is arranged for comparing a second data level DL_2 of the data signal S_D with the predetermined signal S_P to generate a detection result DR. Next, the second processing unit 120 is arranged for selectively correcting an output signal S_OUT according to the detection result DR, wherein the output signal S_OUT is determined according to a level difference between the reset level RL and the first data level DL_1. Please note that, in this embodiment, the proposed eclipse/darkle detection mechanism performs detection/correction based on the comparison of the second data level DL_2 rather than relying on the reset level RL comparison to a constant threshold. Due to the lower sensitivity of the floating diffusion node compared to the photodiode sensitivity, the eclipse/darkle detection mechanism presented is more effective. In another embodiment in the second operation mode, the first processing unit 110 may use the first data level DL_1 to compare with the predetermined signal S_P, instead of using the second data level DL_2.

In addition, the first processing unit 110 may include at least one circuit component shared between the first operation mode and the second operation mode. In one embodiment, the first processing unit 110 may include a pixel level or column level signal amplifier that supports multi-function as the eclipse/darkle (e.g. dark/black/grey sun) detection and correction after the detection result DR is obtained by comparing the second data level DL_2 to the predetermined signal S_P. The detection result DR may be used to determine whether the eclipse/darkle (e.g. dark/black/grey sun) phenomenon has occurred. The eclipse/darkle phenomenon is corrected by applying a high signal level to the resulting output signal S_OUT (obtained based on the level difference between the reset level RL and the first data level DL_1) of the pixel level or column level signal amplifier via a different signal path. More practically, the first processing unit 110 may be used as an amplifier when the CDS apparatus 100 enters the first operation mode, and the first processing unit 110 maybe used as a comparator when the CDS apparatus 100 enters the second operation mode. In one implementation, during a data signal readout period of the CDS apparatus 100 (i.e. after receiving the reset signal S_R), the first processing unit 110 receives the second data level DL_2 after receiving the first data level DL_1, which may further improve the sensitivity of the eclipse/darkle detection.

In one implementation, the first processing unit 110 may act as a threshold-based comparator in the second operation mode, and the detection result DR may be an indicator that indicates the occurrence of the eclipse/darkle (e.g. dark/black/grey sun) phenomenon. Thus, the resulting output signal S_OUT obtained based on the level difference between the reset level RL and the first data level DL_1 may be corrected according to the logic levels (corresponding to digital values 0 and 1) of the detection result DR. For example, when the detection result DR has a predetermined logic level, the second processing unit 120 may correct the output signal S_OUT by directly adjusting a signal level of the output signal S_OUT. In an alternative design, the second processing unit 120 may selectively correct the output signal S_OUT by selectively correcting at least one of the reset signal level RL and the first data level DL_1 according to the detection result DR. That is, the signal level of the output signal S_OUT may be adjusted indirectly by correcting the reset signal level RL and/or the first data level DL_1. For example, when the detection result DR has a predetermined logic level, the second processing unit 120 may correct the reset level RL by increasing the reset level RL of the reset signal S_R. In one implementation, when the detection result DR has a predetermined logic level, the second processing unit 120 may correct the first data level DL_1 by decreasing the first data level DL_1 of the data signal S_D.

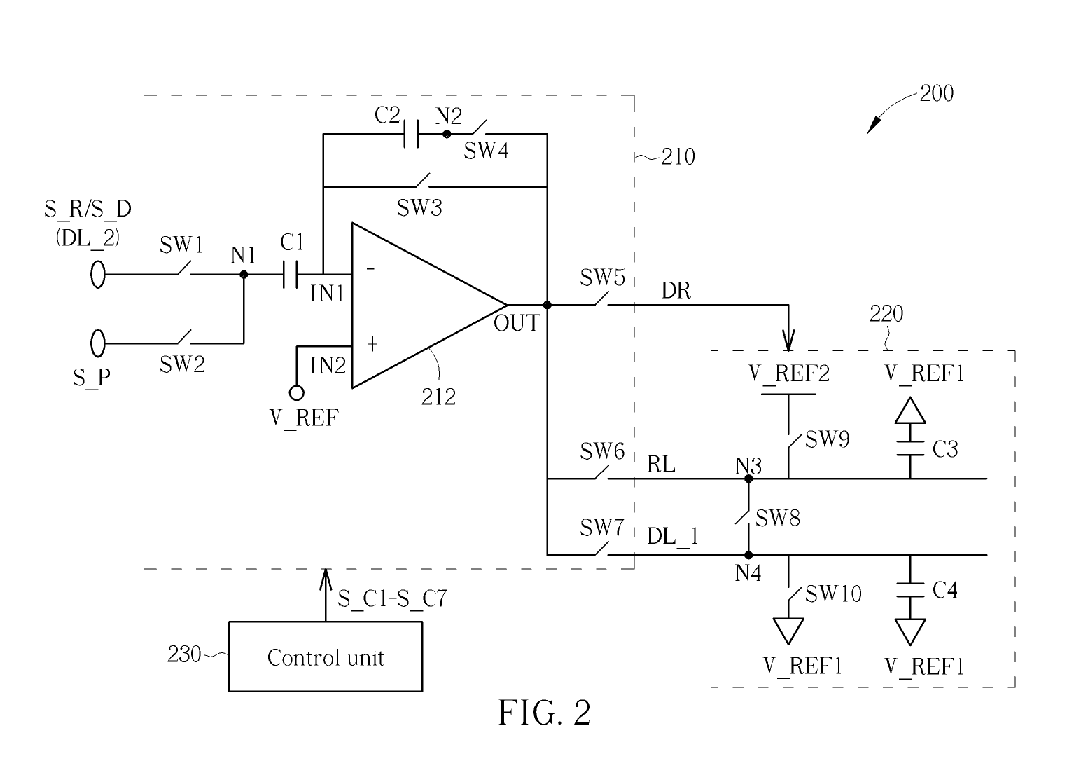

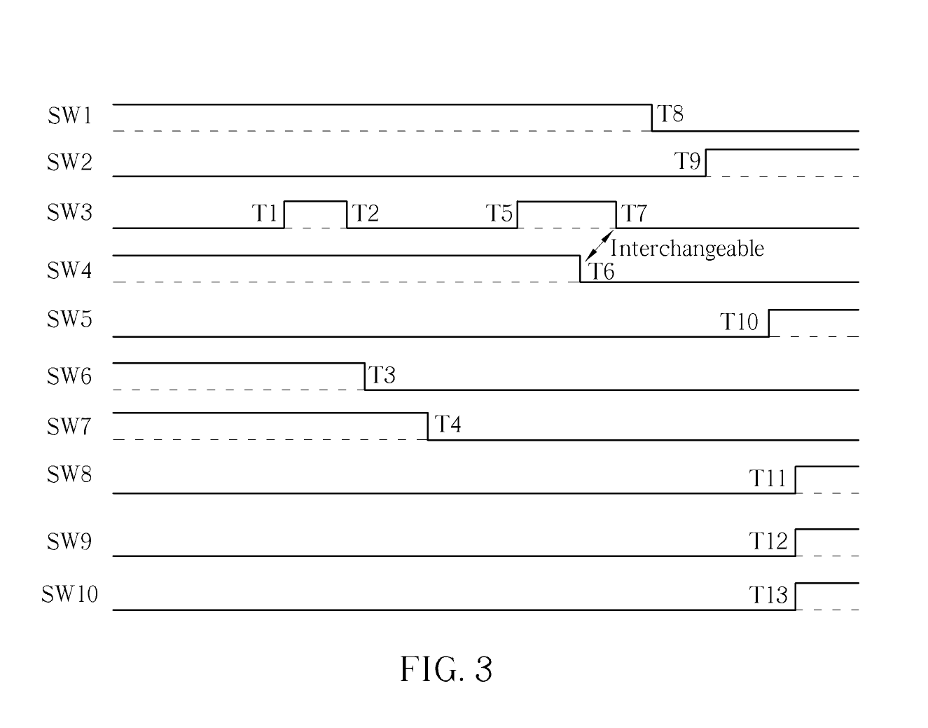

Please refer to FIG. 2 and FIG. 3 together. FIG. 2 is a diagram illustrating an exemplary implementation of the CDS apparatus 100 shown in FIG. 1, and FIG. 3 is a timing diagram illustrating the timing sequence corresponding to the CDS apparatus 200. As shown in FIG. 2, the CDS apparatus 200 includes, but is not limited to, a first processing unit 210, a second processing unit 220, and a control unit 230, wherein the first processing unit 110 shown in FIG. 1 may be implemented by the first processing unit 210, and the second processing unit 120 shown in FIG. 1 may be implemented by the second processing unit 220. The control unit 230 is coupled to the first processing unit 210, and arranged for generating a plurality of control signals SC_1-SC_7. The first processing unit 210 includes, but is not limited to, an amplifier 212, a plurality of capacitors C1 and C2, and a plurality of switches SW1-SW7. The amplifier 212 has a first input port IN1, a second input port IN2, and an output port OUT, wherein the second input port IN2 is coupled to a reference voltage V_REF. The capacitor C1 is coupled between a specific node N1 and the first input port IN1, and the capacitor C2 is coupled to the first input port IN1 and a specific node N2.

In addition, the switch SW1 is arranged for selectively coupling either the reset signal S_R or the data signal S_D to the specific node N1 according to the control signal S_C1; the switch SW2 is arranged for selectively coupling the predetermined signal S_P to the specific node N1 according to the control signal S_C2; the switch SW3 is arranged for selectively coupling the first input port IN1 to the output port OUT according to the control signal S_C3; the switch SW4 is arranged for selectively coupling the specific node N2 to the output port OUT according to the control signal S_C4; the switch SW5 is arranged for selectively coupling the output port OUT to the second processing unit 220 according to the control signal S_C5, wherein when the switch SW5 is switched on by the control signal S_C5, the second processing unit 220 is allowed to receive the detection result DR; the switch SW6 is arranged for selectively coupling the output port OUT to the second processing unit 220 according to the control signal S_C6, wherein when the switch SW6 is switched on by the control signal S_C6, the second processing unit 220 is allowed to store the reset level RL; and the switch SW7 is arranged for selectively coupling the output port OUT to the second processing unit 220 according to the control signal SC_7, wherein when the switch SW7 is switched on by the control signal SC_7, the second processing unit 220 is allowed to store the first data level DL_1.

As shown in FIG. 3, in the first operation mode (e.g. the normal CDS operation), the switch SW3 is first switched on and then switched off respectively at the transitions T1 and T2 for resetting the amplifier 212. Then the first processing unit 210 receives the reset signal S_R from a previous stage (e.g. a pixel including a photodiode). After the first processing unit 210 receives the reset signal S_R, the switch SW6 is switched off at the transition T3 for the second processing unit 220 to store the reset level RL corresponding to the reset signal S_R to the capacitor C3 via a feedback amplifier (composed of the amplifier 212, the capacitor C1, and the capacitor C2). Between the transitions T3 and T4, the data signal transferred via the photodiode (not shown in FIG. 2) occurs, and the first data level DL_1 of the data signal S_D is sampled at the transition T4 (i.e. the switch SW7 is switched off) and stored in the capacitor C4 of the second processing unit 220. Up until this time point, the aforementioned timing sequence is consistent with the regular CDS operation using a column level or pixel level amplifier.

Next, in the second operation mode, the switch SW3 is switched on at the transition T5 again for resetting the feedback amplifier (composed of the amplifier 212, the capacitor C1, and the capacitor C2). In the second operation mode, the amplifier 212 acts as a comparator by switching off the switches SW3 and SW4 at the transitions T6 and T7, wherein the transitions T6 and T7 may be interchangeable. When the switch SW1 is switched off and the switch SW2 is switched on in sequence at the transitions T8 and T9, the photodiode signal path of the previous stage is disconnected from the specific node N1, and the predetermined signal S_P is connected to the specific node N1 for the amplifier 212 to compare with the second data level DL_2. When the switch SW5 is switched on at the transition T10, the detection result DR present at the output port OUT of the amplifier 212 resulting from the comparison of the second data level DL_2 with the predetermined signal S_P may be stored as a logic level (e.g. a digital value) to the stage following the switch SW5 (e.g. a capacitor). In one implementation, when the detection result DR indicates the occurrence of the eclipse/darkle phenomenon (e.g. the detection result DR has a predetermined logic level), the first data level DL_1 and the reset level RL stored in the second processing unit 220 may be saturated to the maximum level for correcting the eclipse/darkle phenomenon (e.g. the dark sun phenomenon).

In this embodiment, the second processing unit 220 shown in FIG. 2 includes, but is not limited to, a plurality of capacitors C3 and C4, and a plurality of switches SW8-SW10. The capacitor C3 is coupled between a specific node N3 and a reference voltage V_REF1, and arranged for storing the reset level RL. The capacitor C4 is coupled between a specific node N4 and the reference voltage V_REF1, and arranged for storing the first data level DL_1. In addition, the switch SW8 is arranged for selectively coupling the specific node N3 to the specific node N4; the switch SW9 is arranged for selectively coupling the specific node N3 to a reference voltage V_REF2; and the switch SW10 is arranged for selectively coupling the specific node N4 to the reference voltage V_REF1. In this embodiment, when the CDS apparatus 200 is operated in the first operation mode, the switches SW8-SW10 are switched off, and when the CDS apparatus 200 is operated in the second operation mode, the switches SW8-SW10 are controlled according to the detection result DR. Consider a case where the reference voltage V_REF2 is a high level voltage and the reference voltage V_REF1 is a low level voltage. If the detection result DR has a first predetermined logic level, which indicates that no eclipse/darkle phenomenon occurs, the switch SW8 is switched on (i.e. the transition T11), and the switches SW9 and SW10 are switched off; if the detection result DR has a second predetermined logic level different from the first predetermined logic level, which indicates the occurrence of the eclipse/darkle phenomenon, the switch SW8 is switched off, and the switches SW9 and SW10 are switched on (i.e. the transitions T12 and T13). To put it another way, the switches SW9 and SW10 are used to replace the action of the switch SW8 to correct the dark/black/grey sun phenomenon, wherein the switch SW8 is traditionally used to obtain the offset signal (corresponding to the reset signal S_R and the data signal S_D) for the next stage (e.g. the subtraction circuitry) when there is no dark sun detection and correction mechanism. In this embodiment, when there is a dark/black/grey sun phenomenon, the transitions T12 and T13 may replace the transition T11 for transferring signals to the next stage (e.g. the subtraction circuitry) by turning on both switches SW9 and SW10, instead of the switch SW8, to increase/saturate the output signal S_OUT corresponding to the level difference between the reset level RL and the first data level DL_1. In one implementation, the reference voltage V_REF2 may be the highest potential present, and the reference voltage V_REF1 may be the lowest potential present.

It should be noted that the implementation of the second processing unit 220 described above is for illustrative purpose only. For example, switching on only one of the switches SW9 and SW10 may also be feasible. In other words, any circuitry capable of adjusting the output signal S_OUT (corresponding to the level difference between the reset level RL and the first data level DL_1) according to the detection result DR falls within the scope of the present invention. In addition, minor modifications to the timing sequence shown in FIG. 3 can be made to achieve similar functionality, and the timing sequence drawn is not to scale and only indicates a general sequencing used in one preferred embodiment of the invention.

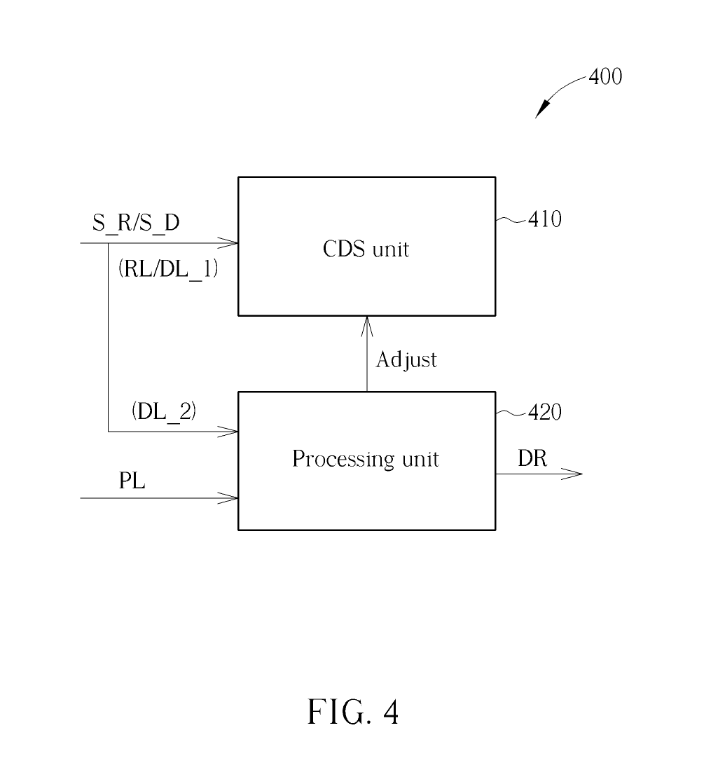

As can be understood from the above description, a first pixel or column level stage present in the amplification process (e.g. the amplifier 212) maybe reused as a comparison device after the normal CDS operation is finished. In one embodiment, it may also be feasible to employ a column level or pixel level comparison device. Please refer to FIG. 4, which is a block diagram illustrating an exemplary signal processing apparatus according to an embodiment of the present invention. The exemplary signal processing apparatus 400 includes, but is not limited to, a correlated double sampling (CDS) unit 410 and a processing unit 420. The CDS unit 410 is arranged for receiving a reset signal S_R and a data signal S_D, obtaining a reset level RL and a first data level DL_1 corresponding to the reset signal S_R and the data signal S_D, respectively, and outputting an output signal S_OUT according to a level difference between the reset level RL and the first data level S_D, wherein the data signal S_D may be read from a pixel unit of the previous stage. The processing unit 420 is coupled to the CDS unit 410, and arranged for receiving a second data level DL_2 of the data signal S_D and a predetermined level PL, and comparing the second data level DL_2 with the predetermined level PL to generate a detection result DR indicative of quality of the level difference. The detection principle of the eclipse/darkle phenomenon employed by the signal processing apparatus 400 is mainly based on the detection principle employed by the CDS apparatus 100/200 shown in FIG. 1/FIG. 2, and the major difference between the signal processing apparatus 400 and the CDS apparatus 100/200 shown in FIG. 1/FIG. 2 is that the signal processing apparatus 400 performs the eclipse/darkle detection by a processing device (e.g. the processing unit 420) external to a CDS device (e.g. the CDS unit 410) rather than re-using the CDS device. Similarly, in order to improve the sensitivity of the eclipse/darkle detection, the processing unit 420 receives the second data level DL_2 after the CDS unit 410 receives the first data level DL_1 during a data signal readout period of the CDS unit 410 (i.e. after receiving the reset signal S_R).

The signal processing apparatus 400 may also be able to correct the eclipse/darkle phenomenon (e.g. the dark/black/grey sun phenomenon). By way of example, but not limitation, the processing unit 420 may include a circuit component having elements similar to the aforementioned feedback amplifier (composed of the amplifier 212, the capacitor C1, and the capacitor C2 shown in FIG. 2) and switching design to increase/saturate the output signal S_OUT corresponding to the level difference between the reset level RL and the first data level DL_1. Therefore, in one implementation, the processing unit 420 may further selectively correct the output signal S_OUT according to the detection result DR, and when the detection result DR has a predetermined logic level, the processing unit 420 may correct the output signal S_OUT by directly adjusting a signal level of the output signal S_OUT. In an alternative design, the processing unit 420 may selectively correct the output signal S_OUT by selectively correcting at least one of the reset level RL and the first data level DL_1 according to the detection result DR. For example, when the detection result DR has a predetermined logic level, the processing unit 420 may correct the reset level RL by increasing the reset level RL of the reset signal S_R, or correct the first data level DL_1 by decreasing the first data level DL_1 of the data signal S_D. As a person skilled in the art can readily understand the operation of the signal processing apparatus 400 after reading the above paragraphs directed to FIG. 1-FIG. 3, further description is omitted here for brevity.

In summary, the eclipse/darkle detection mechanism has a higher sensitivity than methods which rely on a reset level comparison.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A signal processing apparatus, comprising:
a correlated double sampling unit, for receiving a reset signal and a data signal, obtaining a reset level and a first data level corresponding to the reset signal and the data signal, respectively, and outputting an output signal according to a level difference between the reset level and the first data level; and
a processing unit, coupled to the correlated double sampling unit, for receiving a second data level of the data signal and a predetermined level, and comparing the second data level with the predetermined level to generate a detection result indicative of quality of the level difference.

2. The signal processing apparatus of claim 1, wherein during a data signal readout period of the correlated double sampling unit, the processing unit receives the second data level after the correlated double sampling unit receives the first data level.

3. The signal processing apparatus of claim 1, wherein the processing unit further selectively corrects the output signal according to the detection result.

4. The signal processing apparatus of claim 3, wherein when the detection result has a predetermined logic level, the processing unit corrects the output signal by directly adjusting a signal level of the output signal.

5. The signal processing apparatus of claim 3, wherein the processing unit selectively corrects the output signal by selectively correcting at least one of the reset level and the first data level according to the detection result.

6. The signal processing apparatus of claim 5, wherein when the detection result has a predetermined logic level, the processing unit corrects the reset level by increasing the reset level of the reset signal.

7. The signal processing apparatus of claim 5, wherein when the detection result has a predetermined logic level, the processing unit corrects the first data level by decreasing the first data level of the data signal.

8. The signal processing apparatus of claim 1, wherein the data signal is read from a pixel unit.
